(19) United States
(12) Patent Application Publication
(10) Pub. No.: US 2025/0045575 A1
(43) Pub. Date: Feb. 6, 2025

(54) ENHANCING TRANSFER LEARNING FOR LARGE LANGUAGE MODELS

(71) Applicant: Roku, Inc., San Jose, CA (US)

(72) Inventors: Abhishek Majumdar, Santa Clara, CA (US); Kapil Kumar, London (GB); Nitish Aggarwal, Sunnyvale, CA (US); Danish Nasir Shaikh, Daly City, CA (US); Manasi Deshmukh, San Francisco, CA (US); Apoorva Jakalannanavar Halappa Manjula, San Francisco, CA (US)

(73) Assignee: Roku, Inc., San Jose, CA (US)

(21) Appl. No.: 18/423,802

(22) Filed: Jan. 26, 2024

Related U.S. Application Data
(60) Provisional application No. 63/516,716, filed on Jul. 31, 2023.

(51) Int. Cl. G06N 3/08

(52) U.S. Cl. CPC G06N 3/08

(57) ABSTRACT

Pre-trained large language models may be trained on a large data set which may not necessarily align with specific tasks, business goals, and requirements. Pre-trained large language models can solve generic semantic relationship or question-answering type problems but may not be suited for content item retrieval or recommendation of content items that are semantically relevant to a query. It is possible to build a machine learning model while using transfer learning to learn from pre-trained large language models. Training data can significantly impact the performance of machine learning models, especially machine learning models developed using transfer learning. The training data can impact a model's performance, generalization, fairness, and adaptation to specific domains. To address some of these concerns, a popularity bucketing strategy can be implemented to debias training data. Optionally, an ensemble of models can be used to generate diverse training data.

### CROSS-REFERENCE TO RELATED APPLICATIONS

This non-provisional application claims priority to and/or receives benefit from provisional application, titled “ENHANCING TRANSFER LEARNING FOR LARGE LANGUAGE MODELS”, Ser. No. 63/516,716, filed on Jul. 31, 2023. The provisional application is hereby incorporated by reference in its entirety.

### TECHNICAL FIELD

This disclosure relates generally to large language models, and more specifically, enhancing transfer learning by improving training data used in transfer learning for large language models.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates transfer learning, according to some embodiments of the disclosure.

FIG. 2 illustrates exemplary data sources used in generating training data, according to some embodiments of the disclosure.

FIG. 3 illustrates exemplary bucketizing content items based on popularity scores, according to some embodiments of the disclosure.

FIG. 4A depicts an exemplary plot of popularity scores of a number of content items, and considerations when bucketizing the content items, according to some embodiments of the disclosure.

FIG. 4B depicts an exemplary plot of number of content items per percentile group, according to some embodiments of the disclosure.

FIG. 4C depicts an exemplary plot of popularity scores for each percentile group, according to some embodiments of the disclosure.

FIG. 4D depicts an exemplary table of statistics about the popularity scores for each percentile group, according to some embodiments of the disclosure.

FIG. 4E depicts an exemplary plot of number of content items per Pareto group, according to some embodiments of the disclosure.

FIG. 4F depicts an exemplary plot of popularity scores for each Pareto group, according to some embodiments of the disclosure.

FIG. 4G depicts an exemplary table of statistics about the popularity scores for each Pareto group, according to some embodiments of the disclosure.

FIG. 4H depicts an exemplary plot of number of content items per geometric progression group, according to some embodiments of the disclosure.

FIG. 4I depicts an exemplary plot of popularity scores for each geometric progression group, according to some embodiments of the disclosure.

FIG. 4J depicts an exemplary table of statistics about the popularity scores for each percentile group, according to some embodiments of the disclosure.

FIG. 5 depicts debiasing training data and retrieval of top K items from each content item buckets, according to some embodiments of the disclosure.

FIG. 6 depicts retrieval of top K items (e.g., closest K nearest neighbors) from a content item bucket, according to some embodiments of the disclosure.

FIG. 7 depicts using an ensemble of models to generate diverse and debiased training data, according to some embodiments of the disclosure.

FIG. 8 is a flowchart showing a method for bucketizing content items based on popularity scores, according to some embodiments of the disclosure.

FIG. 9 is a flowchart showing a method for generating training data and using the training data in training a machine learning model, according to some embodiments of the disclosure.

FIG. 10 is a block diagram of an exemplary computing device, according to some embodiments of the disclosure.

### DETAILED DESCRIPTION

### Overview

Pre-trained large language models may be trained on a large data set which may not necessarily align with specific tasks, business goals, and requirements. Pre-trained large language models can solve generic semantic relationship or question-answering type problems but may not be suited for content item retrieval or recommendation of content items that are semantically relevant to a query. It is possible to build a machine learning model while using transfer learning to learn from pre-trained large language models. Training data can significantly impact the performance of machine learning models, especially machine learning models developed using transfer learning. The training data can impact a model's performance, generalization, fairness, and adaptation to specific domains.

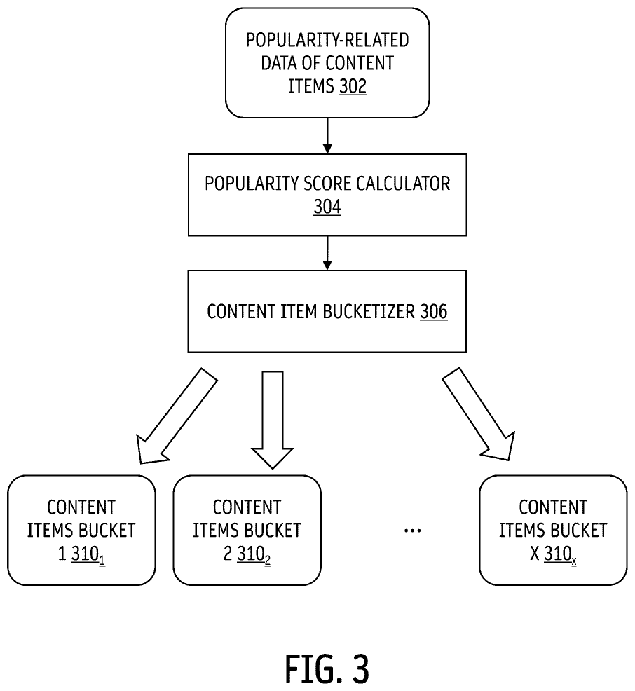

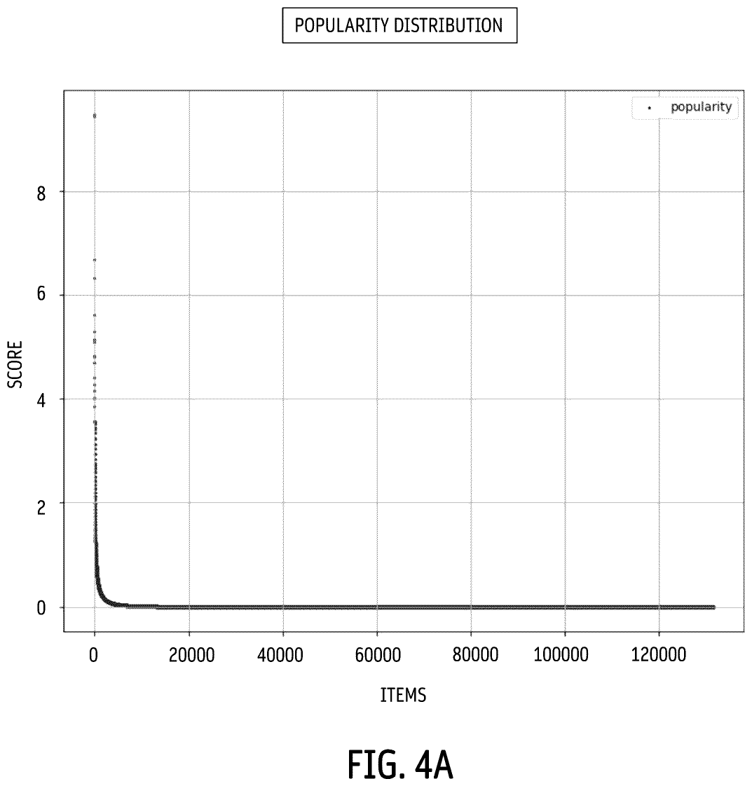

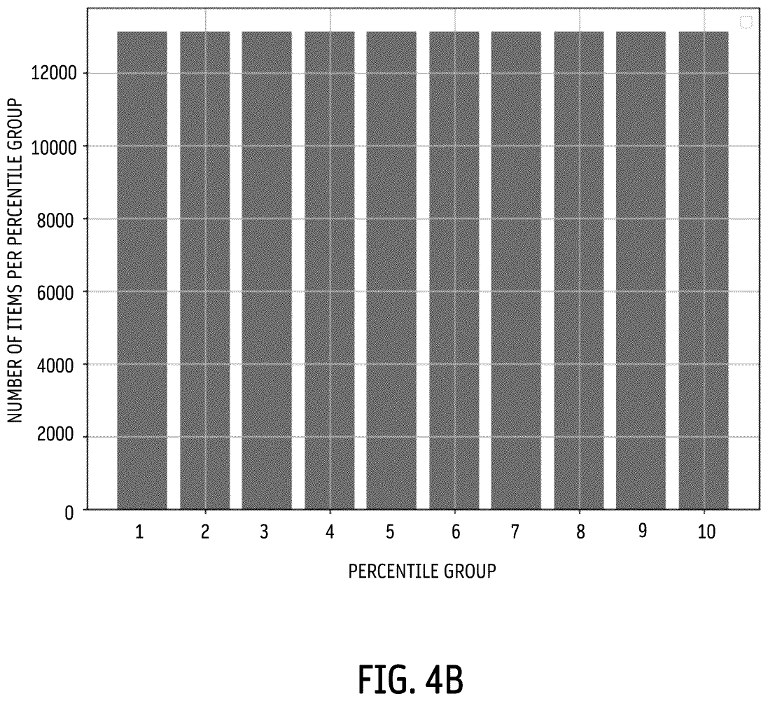

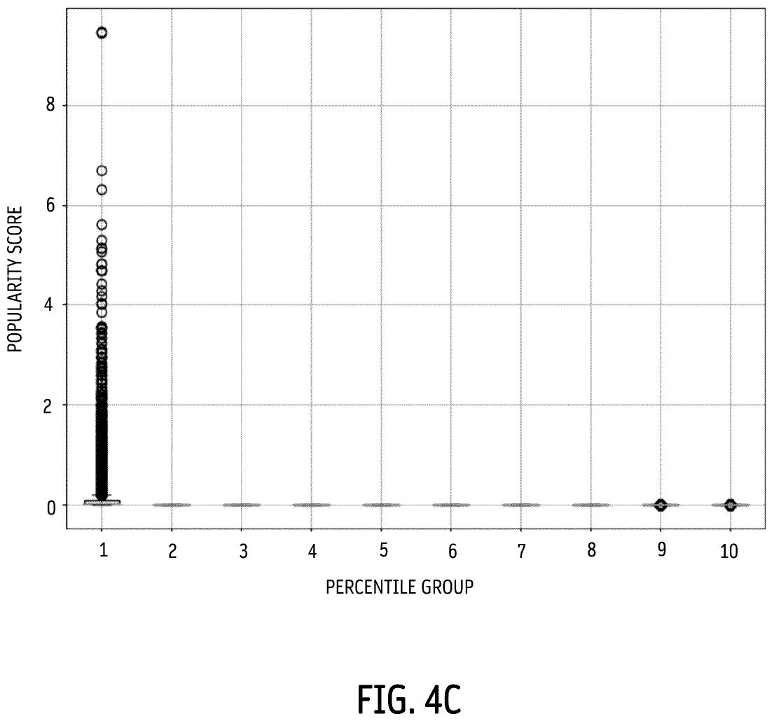

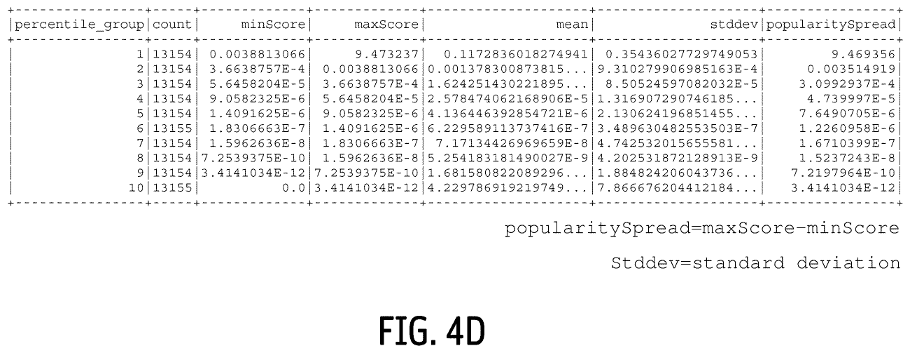

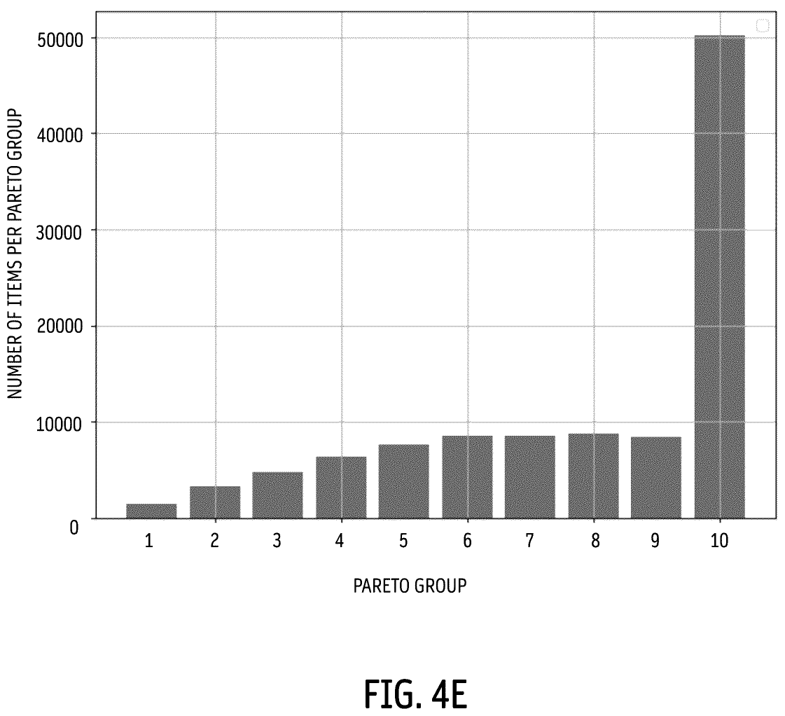

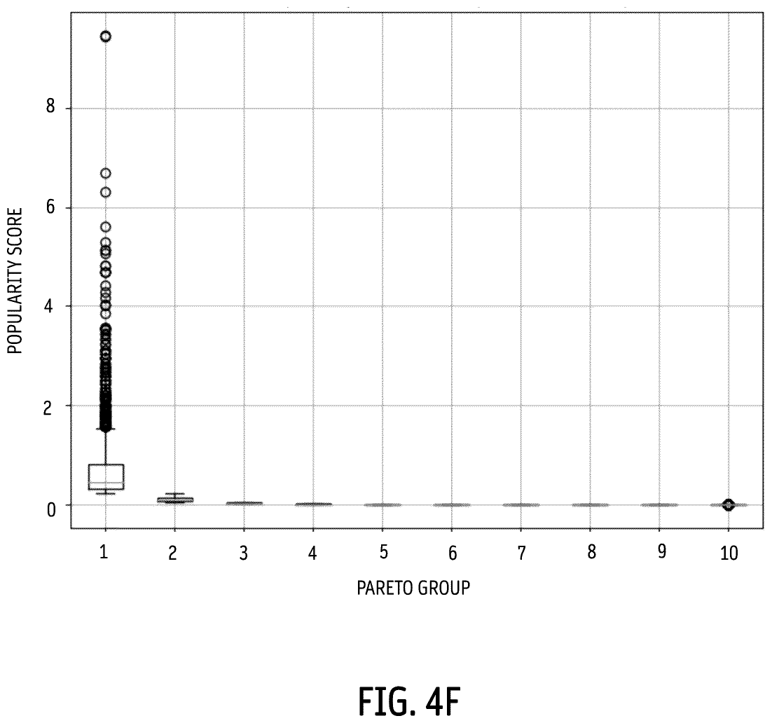

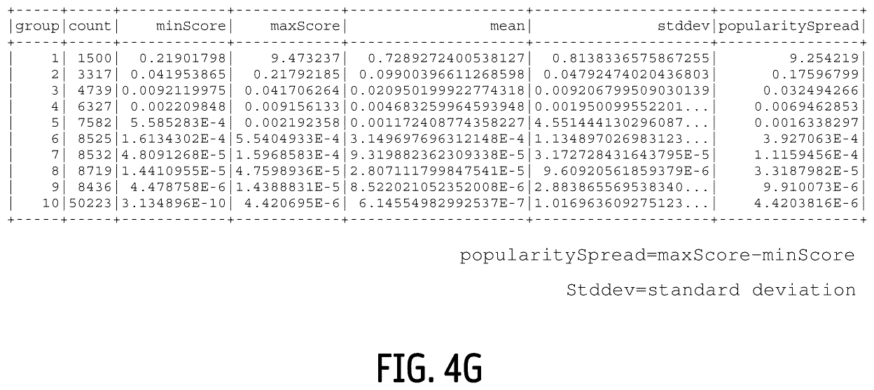

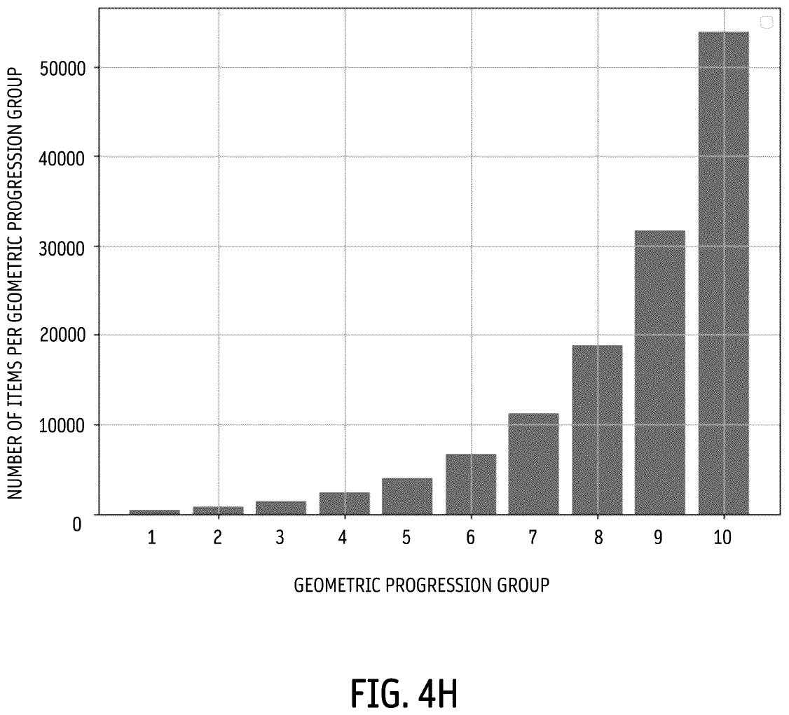

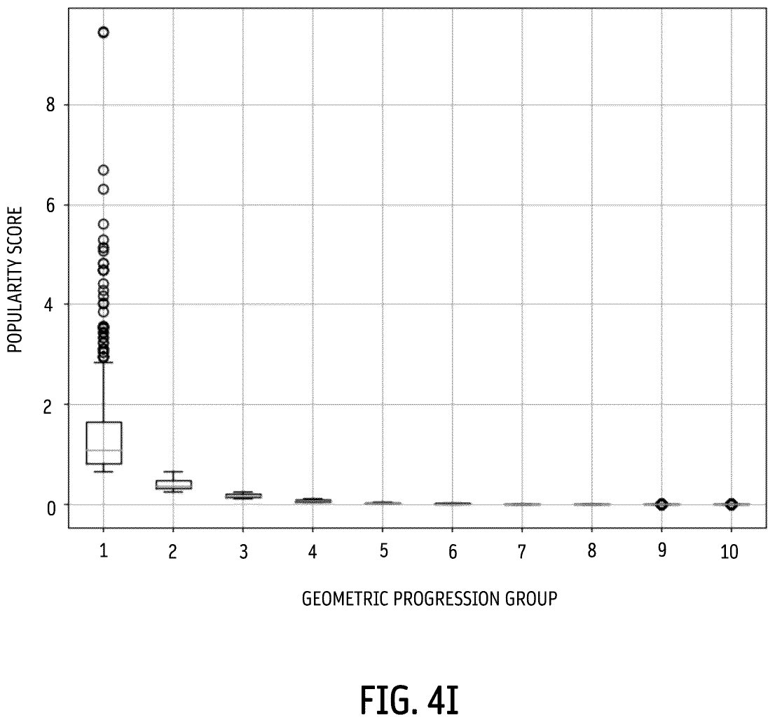

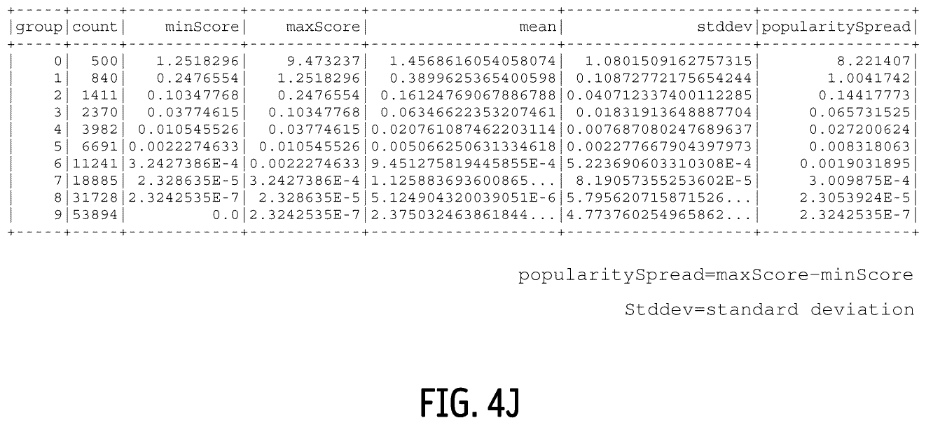

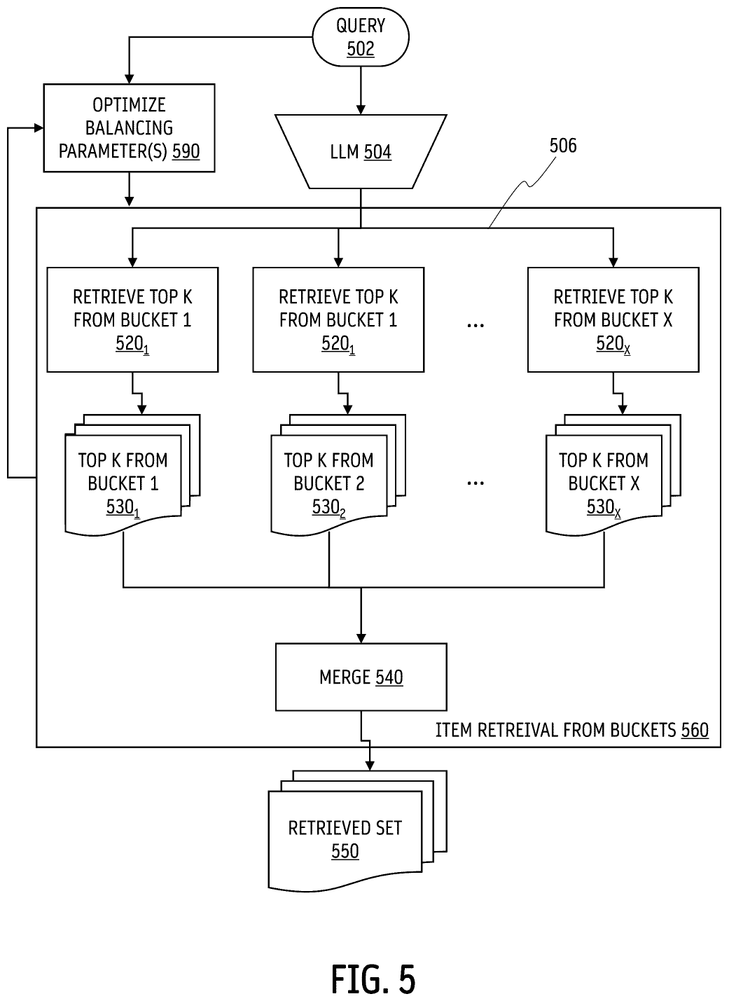

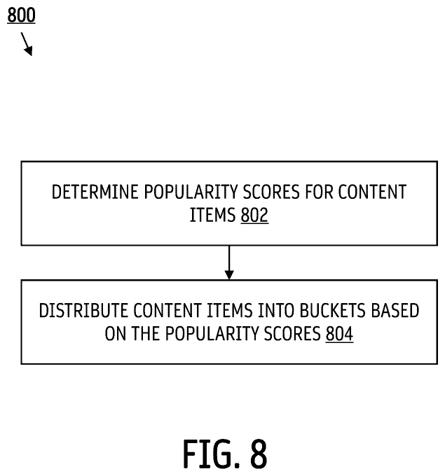

To address some of these concerns, a popularity bucketing strategy can be implemented to debias training data. A bucketizing technique is illustrated in FIG. 3. A method for bucketizing content items is illustrated in FIG. 8. Different approaches to bucketizing are illustrated in FIGS. 4A-G. Debiasing techniques are illustrated in FIGS. 5-7. Optionally, an ensemble of models can be used to generate diverse training data. A method for debiasing training data is illustrated in FIG. 8.

Challenges with Semantic Search

Content providers may manage and allow users to access and view thousands to millions or more content items. Content items may include media content, such as audio content, video content, image content, augmented reality content, virtual reality content, mixed reality content, game, textual content, interactive content, etc. Finding exactly what a user is looking for, or finding what the user may find most relevant can greatly improve the user experience. In some cases, a user may provide voice-based or text-based queries to find content items. Examples of queries may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?” and
“I want to see a film set in Tuscany but is not dubbed in English.”

Machine learning models can be effective in interpreting a query and finding content items that may match with the query. Machine learning models may implement natural language processing to interpret the query. Machine learning models may include one or more neural networks (e.g., transformer-based neural networks). Machine learning models may include a large language model (LLM). User experience with retrieval of content items in response to a query can depend on whether the machine learning models can retrieve content items that the user is looking for in the query.

### Transfer Learning

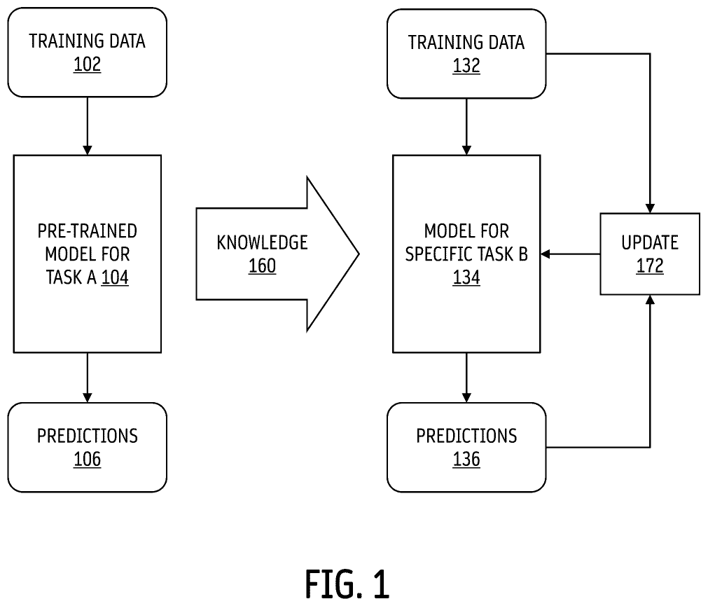

FIG. 1 illustrates transfer learning, according to some embodiments of the disclosure. Transfer learning is a technique in machine learning that involves using the knowledge learned from one task to improve the performance on a related but different task. For example, a model that can recognize cars can use its learned features to recognize trucks more easily. Transfer learning is useful when there is not enough training data for the new task, and when the new task is similar to the previous one. Transfer learning can be used to develop a potentially more lightweight model with a reasonable amount of training data based on a heavyweight model that is already pre-trained.

Pre-trained (or off-the-shelf) model for task A 104 may include a machine learning model, such as an LLM. Task A may include a generalized task, or a specific task. Pre-trained model for task A 104 may have been trained with large amounts of training data 102 to generate large number of predictions 106. Pre-trained model for task A 104 may have tens of millions to billions of weights. Training data 102 may include general text data from the Internet. Pre-trained model for task A 104 is unlikely to be suitable for a specific task with certain business goals and requirements. Pre-trained model for task A 104 may perform well when solving generic semantic relationship or question-answering type problems. Pre-trained model for task A 104 may perform poorly in a specific domain, e.g., retrieval or recommendation of content items that are semantically relevant to the query while being relevant for business.

It is possible to adapt pre-trained model for task A 104 using transfer learning to develop a model for specific task B 134. Specific task B may involve semantic search for content items, e.g., retrieval or recommendation of content items that are semantically relevant to the query. Model for specific task B 134 may be used in a content item retrieval system/engine or a content item recommendation system/engine. Through transfer learning, pre-trained model for task A 104 may be used as a starting point for developing model for specific task B 134. Knowledge 160 from pre-trained model for task A 104 can be transferred to model for specific task B 134. Model for specific task B 134 may be trained to perform specific task B (different from task A). Training data 132 can be provided to model for specific task B 134 and model for specific task B 134 can make predictions 136 from the training data 132. Training data 132 and predictions 136 can be used to train model for specific task B 134. Update 172 can examine an error in the predictions 136 based on training data 132 and compute a loss function. An error may be based on whether a given prediction corresponds to ground truth presented in the training data 132. Using the loss function, update 172 can update weights used in model for specific task B 134 accordingly so that model for specific task B 134 continues to improve. Update 172 may update the weights used in the model for specific task B 134 to minimize the loss function.

Machine learning models, such as model for specific task B 134, can be trained using loss functions by following a process called optimization. Optimization is the task of finding the best set of parameters (e.g., weights) for a machine learning model that minimizes the loss function. The loss function can measure how well the model fits the data and how close its predictions are to the true values. The lower the loss function value, the better the model performance. Examples of methods of optimization may include: gradient descent, stochastic gradient descent, and Adam. These methods use different strategies to update the parameters (e.g., weights) of the model based on the gradient of the loss function. The gradient is a vector that points in the direction of the steepest increase of the loss function. By moving in the opposite direction of the gradient, the parameters (e.g., weights) can be adjusted to reduce the loss function value. The optimization process can be iterative and requires multiple passes over the data to converge to a good solution. The number of iterations and the learning rate (how much the parameters change in each step) are hyperparameters that can affect the speed and quality of the optimization.

Transfer learning may involve adding artificial neural network layers to existing artificial neural network layers of pre-trained model for task A 104 and updating the weights in the added artificial neural network layers in training while not updating the weights of the existing artificial neural network layers. Transfer learning may involve using the pre-trained model for task A 104 as a feature extraction model and adding one or more artificial neural network layers to further process the features extracted by the pre-trained model for task A to build model for specific task B 134. Training data 132 and predictions 136 can be used by update 172 to train the added artificial neural network layers. Transfer learning may involve update 172 fine-tuning the weights of one or more existing artificial neural network layers transferred from pre-trained model for task A 104.

The performance of model for specific task B 134, how well model for specific task B 134 performs task B, can depend on training data 132. If poor quality training data 132 goes in, the parameters (e.g., weights) of the model for specific task B 134 would try to fit to poor quality training data 132. As a result, the model for specific task B 134 would make poor quality predictions and perform poorly. Conversely, if good quality training data 132 goes in, the parameters (e.g., weights) of the model for specific task B 134 would try to fit to good quality training data 132. As a result, the model for specific task B 134 would make better quality predictions and perform better.

Training data 132 may be poor for one or more reasons. Training data 132 may be biased. Training data 132 may not be aligned with business goals or requirements. Training data 132 may be noisy. Training data 132 may be agnostic to other affinities besides semantic affinity. Aspects of training data 132 can impact model for specific task B 134's performance, generalization, fairness, and adaptation to perform specific task B.

In some cases, model for specific task B 134 may be trained using training data 132 which includes labeled data entries in the following format:
{query} {content_item(s)}→{match_value(s)}

A labeled data entry may include a query. A labeled data entry may include one or more content items. A labeled data entry may include one or more match values corresponding to one or more content items.

Query portion in a labeled data entry may include a string. Query may include semantic information. Query may include one or more tokens. Query may include one or more words. Query may have semantic meaning. Query may include a question. Query may include a sentence or statement.

Content_item portion in a labeled data entry may include one or more content item identifiers corresponding to one or more content items. A content item identifier may include a (unique) text descriptor describing a content item. A content item identifier may include a hash value generated from the content item. A content item identifier may include a (unique) numerical value. A content item identifier may include a (unique) resource locator to the content item, or information about the content item. A content item identifier may include a (unique) path to the content item, or information about the content item. A content item identifier may include content item metadata, or other suitable information about the content item.

Match_value portion in a labeled data entry may include one or more labels (or one or more ground truth labels) corresponding to one or more content items identified in content_item respectively. A content item identified in content_item may have one or more corresponding labels or ground truth labels. A label may indicate an affinity or a match of a given content item to the query, e.g., along a particular dimension. In some cases, a content item identified in content_item may have an affinity value vector or a match value vector having one or more match/affinity values along different dimensions measuring or quantifying affinity/match of the given content item to the query. Exemplary affinity/match dimensions may include dimensions or features of a content item, such as, title, genre, description, plot, metadata, sentiment, popularity, etc. An exemplary affinity/match value vector may include a plurality of affinity/match values for a content item identified in content_item of a labeled data entry to the query, e.g., [title to query affinity, genre to query affinity, sentiment to query affinity, metadata to query affinity]. Some exemplary affinity/match dimensions may include dimensions or features of the query, such as, keywords or salient words/tokens in the query, etc. An exemplary affinity/match value vector may include a plurality of affinity/match values for a content item identified in content_item of a labeled data entry to the query, e.g., [query keyword1 affinity, query keyword2 affinity, query keyword3 affinity]. A match/affinity value may be binary (e.g., 0 and 1). A match/affinity value may be selected from +1 and −1. A match/affinity value may be selected from +1, 0, and −1. A match/affinity value may include a value within a range between 0 and 1. A match/affinity value may include a value within a range between +1 and −1.

Example labeled data entries may include:
Query=“Depressing documentary about the ocean”, Content_item=“438673315”, and match_value=“1”
   “438673315” may be a content item identifier, and may correspond to a content item titled, “The Extinction of White Whales in the Atlantic Ocean”
Query=“Mockumentary-style TV series set in Alaska”, Content_item=“147468754”, and match_value=“1”
   “147468754” may be a content item identifier, and may correspond to a content item titled, “Denali Park Rangers Gone Wild”.
Query=“Standup comedy special about food and cats”, Content_item=“687684164”, and match_value=[“0”, “0.5”, “0.7”, “0.2”]
   “687684164” may be a content item identifier, and may correspond to a content item titled, “White House correspondents' dinner 2019 speech compilation”
Query=“Standup comedy special about food and cats”, Content_item=[“546867435”, “33433122”], and match_value=[“0.8”, “0.9”]
   “546867435” may be a content item identifier, and may correspond to a content item titled, “Don't call me a crazy cat lady”
   “33433122” may be a content item identifier, and may correspond to a content item titled, “I'm not alone. I have five cats.”
Query=“Standup comedy special about food and cats”, Content_item=[“546867435”, “33433122”], and match_value=[[“0.3”, “0.5”, “0.4”], [“0.1”, “0.8”, “0.9”]]
   “546867435” may be a content item identifier, and may correspond to a content item titled, “Don't call me a crazy cat lady”
   “33433122” may be a content item identifier, and may correspond to a content item titled, “I'm not alone. I have five cats.”

In some cases, model for specific task B 134 may be used in a search engine or recommendation engine to retrieve, based on a query, semantically relevant content items and/or content items that may be most salient, interesting, or pertinent to the query. In some embodiments, model for specific task B 134 may include a classifier, such as a binary classifier, that determines whether a query matches a content item or not. A classifier may determine a score and applies a cut-off or threshold to the score to determine whether a content item matches the query or not. Model for specific task B 134 may include a machine learning model, such as a large language model, that can output a probability score or other suitable score that quantifies or predicts whether a content item matches a query. A large language model may be trained to give a score or a confidence score that a content item belongs to the query.

In some embodiments, update 172 may compute errors and the loss function based on how close a prediction is from the ground truth label (e.g., whether the prediction is a positive). In some embodiments, model for specific task B 134 may include a model which is trained using a triplet loss function. Update 172 may compute errors and the loss function based on how close a prediction is to a positive ground truth label and how far away the prediction is from a negative ground truth label. Update 172 may minimize the distance to the positive ground truth label and maximize the distance from the negative ground truth label when updating weights of model for specific task B 134.

### Exemplary Data Sources Used for Generating Training Data

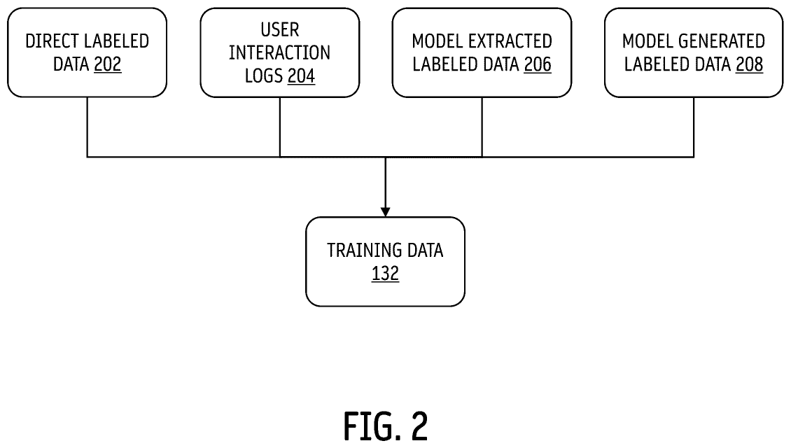

FIG. 2 illustrates exemplary data sources used in generating training data, according to some embodiments of the disclosure. Training data 132 may be generated from one or more data sources, such as direct labeled data 202, user interaction logs 204, model extracted labeled data 206, and model generated labeled data 208.

Direct labeled data 202 may include labeled data extracted from data sources such as the Internet, curated content on the Internet, peer-reviewed content on the Internet, editor/domain expert tagged or labeled content, and content item metadata databases. Data sources may include direct mapping of query to content items, which can be easily translated into labeled data entries for use as part of training data 132. Direct labeled data 202 may be agnostic to considerations such as popularity, streaming hours, and/or click-through rate. For a query involving drama, a majority of content items may be tagged or labeled with drama as the genre, and most of these items may be unpopular (e.g., rarely clicked or launched by users). Training on direct labeled data 202 may bias the model to retrieve mainly long-tailed items (e.g., content items that are unpopular, or rarely clicked or launched by users). Direct labeled data 202 can be limited to a fixed set of categories (e.g., queries, tags, or labels) used in the data sources. Some categories may have sparse coverage. Relatively few content items may be associated with categories such as fly fishing, hockey, etc. Sparse categories may limit the model's capability to predict for these categories. Direct labeled data 202 may not capture semantic dimension(s) of a query to a content item. For a query involving “Sherlock Holmes”, direct labeled data 202 may have labeled data entries that associate the query to content items where the content items feature Sherlock Holmes as the character, and not data entries that associate the query to content items where the plots are around detective stories, or British themed stories, or historical events. Direct labeled data 202 may cause the model to overfit to the labeled data entries and cause the model to not pay attention to semantic dimensions of the query.

User interaction logs 204 may include instances or events encoding or capturing how users may have interacted with a content item. An exemplary instance or event is where a user is browsing through a category of content items, and the user subsequently clicks on a content item. An exemplary instance or event is where a user is browsing through a category of content items retrieved based on a query, and a content item appeared to the user (e.g., an impression, appeared in the semantic search results). Another exemplary instance or event is where a user is browsing through a category of content items, and the user subsequently launches a content item. Another exemplary instance or event is where a user is browsing through a category of content items, and the user did not engage with a content item. Another exemplary instance or event is where a user is browsing through a set of content items retrieved based on a user-provided query and interacted with a content item. Another exemplary instance or event is where a user is browsing through a set of content items retrieved based on a user-provided query, and the user subsequently consumed or engaged with a content item from the set for a certain duration. User interaction logs 204 may capture popularity of a content item. User interaction logs 204 may capture user preferences or user habits. User interaction logs 204 may capture variations of queries used by users. User interaction logs 204 can depend on what the users are doing on the user interface. Sometimes, users may randomly engage with or interact with a content item that is irrelevant or unrelated to the query (or category). User interaction logs 204 may involve noisy data entries or false positives. In some cases, user interaction logs 204 may be biased. User interaction logs 204 may be subject to presentation bias because the users are interacting with a user interface, and user behavior may be biased or impacted by the user interface. For example, even though an American action movie is unrelated to a query involving a Spanish comedy movie, user interaction logs 204 may reveal many instances where a user clicks on the enticing graphic of a poster of the American action movie. The instances or events each connecting a query and an interaction with a content item can be translated or reformatted into labeled data entries for use as part of training data 132.

Model extracted labeled data 206 may include labeled data that is generated using a machine learning model, e.g., an LLM, and a generative pre-trained transformer model, etc. A prompt including information about a content item may be provided to the machine learning model, prompting the machine learning model to output a query (e.g., a string, labels, genres, categories, tags, keywords, a summary, etc.) that corresponds to the content item based prompt. For example, a prompt may include a content item's metadata, such as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, etc. A prompt may include a webpage written about the content item. The webpage may be peer-edited or peer-reviewed. The webpage may be fact-checked. The prompt may request the machine learning model to determine, generate, and output possible queries (e.g., strings, genres, categories, tags, keywords, a summary, etc.) that would correspond to the content item. In some cases, the machine learning model may be prompted with information about the content item and asked to generate a summary about the content item. One or more queries (e.g., strings, genres, categories, tags, keywords, a summary, etc.) can be extracted from the summary and used to generate labeled data entries. In some cases, the machine learning model may be prompted with information about the content item and asked to generate one or more queries to which the content item may strongly match. One or more queries (e.g., strings, genres, categories, tags, keywords, a summary, etc.) can be used to generate labeled data entries. The extracted queries and the content item can be translated or reformatted into labeled data entries for use as part of training data 132. Model extracted labeled data 206 may capture semantic dimensions of a query when detailed prompts are used but can be subject to a risk of hallucinations by the machine learning model (e.g., the machine learning model generating queries that are made-up and do not correspond to the content item).

Model generated labeled data 208 may include labeled data that is generated using one or more (machine learning) model that finds the additional semantically relevant content items that correspond to a given query. Model generated labeled data 208 may generate additional labeled data entries based on existing labeled data entries. In some embodiments, the model may build and/or include a semantic graph, knowledge graph, and/or social graph that encode relationships between a library of content items. Once a graph that connects different content items is built, the model may use the graph to generate labeled data. For example, the model may use a given (existing) labeled data entry (e.g., from direct labeled data 202), and determine additional labels by applying techniques such as semantic graph search. Semantic graph search may determine that additional content items are related to a given content item, and therefore, the additional content items may also match the query. The (machine learning) model can implement a search for additional semantically relevant matches to a query on a graph (e.g., through random walk through a semantic graph, knowledge graph, and/or social graph) to find additional content items that are semantically relevant to a query based on the graph. In some embodiments, the machine learning model can extract feature embeddings of content items and find nearest neighbors to a content item that matches a given query, which may have the most similar latent representations or features to the content item. The nearest neighbors can include additional semantically relevant content items to the given query. In some embodiments, a model (e.g., a large language model) be prompted to determine whether one or more additional content items may also be related to a query in the similar way that a given content item is related to a query in a labeled data entry. The additional semantically relevant content items and the query can be translated or reformatted into labeled data entries for use as part of training data 132.

Model extracted labeled data 206 and model generated labeled data 208 may involve processes that do not involve a human in the loop and may be uncontrolled.

Labeled data entries from various data sources may be effective, but can require significant manual effort in fine-tuning, increasing coverage, and while balancing user preference, popularity and semantic affinity or relevance.

### Exemplary Bucketing Strategies

Besides semantic relevance or semantic affinity, users may find content items more relevant or useful when the content items have one or more affinities associated with other features (or attributes) or along other dimensions. In other words, users may find users may find retrieved content items more useful when the content items reflect a balance between affinities associated with different features and/or along different dimensions, e.g., including semantic affinity and one or more other affinities.

Features, attributes, or dimensions of content items may include qualitative and/or quantitative aspects about content items such as popularity (e.g., topical, trending, most-talked about, etc.), popularity among certain demographics of users that consumes the content items, popularity among different devices used for consuming the content items, which cluster(s) the content items belong to, associated revenue generated from the content items, associated revenue that can be generated from the content item, viewer ratings, critic ratings, type of media, etc.

Processes that generate training data 132 can be augmented to balance different affinities, such as popularity and semantic affinity. The processes may include or implement one or more of: a bucketizing technique, a clustering technique, and a technique to distribute or organize content items into buckets, clusters, or cohorts. The processes may produce buckets, clusters, or cohorts based on one or more features, attributes, or dimensions of content items. The processes may generate clusters based on one or more features, or attributes about the content items. The processes may generate buckets using along one or more dimensions about the content items. The processes may generate cohorts where content items within a cohort may share the same or similar features and/or attributes.

In some cases, a clustering technique may be implemented to divide content items into buckets (or clusters) using cluster analysis such as k-means clustering, distribution-based clustering, density based clustering, etc. Identified clusters of content items can be assigned to different buckets. In some cases, one or more scores determined about the content items may be used as input features to a model (e.g., a machine learning model) to determine to which bucket or cluster a content item belongs. In some cases, metadata about the content items may be used as input features to a model (e.g., a machine learning model) to determine to which bucket or cluster a content item belongs. In some cases, dimensions/attributes/features about the content items may be used as input features to a model (e.g., a machine learning model) to determine to which bucket or cluster a content item belongs.

In some cases, a clustering technique may be implemented to divide content items based on one or more dimensions and/or features (e.g., tags, metadata, etc.). about the content items. For example, content items may be divided into buckets based on the source of the content items (e.g., one bucket with content items from a first media company, one bucket with content items from a second media company, etc.). In another example, content items may be divided into buckets based on type of the content item (e.g., movie, audio, podcast, series, limited series, augmented reality content, virtual reality content, game, live content, sports event, etc.). In yet another example, content items may be divided based on demographics (e.g., one bucket with content items popular with age 2-6, one bucket with content items popular with age 7-12, one bucket with content items popular with age 13-18, one bucket with content items popular with age 19-35, one bucket with content items popular with age 35-55, etc.). In yet another example, content items may be divided based on revenue associated with the content items (e.g., one bucket with content items that are free, one bucket with content items that are free with subscription, one bucket with content items that are free with advertisements, one bucket with content items that can be rented, one bucket with content items that can be purchased for less than a first threshold amount, one bucket with content items that can be purchased for less than a second threshold amount, etc.).

While some examples herein describe balancing popularity and semantic affinity, it is envisioned by the disclosure that the examples may also apply to balancing different affinities associated with different features or along different dimensions of content items.

FIG. 3 illustrates exemplary bucketizing content items based on, e.g., popularity scores, according to some embodiments of the disclosure. Bucketizing, clustering, and distribution of content items 302 can be performed using one or more scores associated with or indicative of one or more features, attributes, or dimension of content item.

To find popularity scores, popularity-related data of content items 302 may be determined or retrieved. Popularity scores may be computed based on popularity-related data of content items 302.

In some embodiments, popularity-related data of content items 302 may be windowed to include data in the last Z number of days (only). Z may be 30.

In some embodiments, popularity-related data of content items 302 may include popularity data for content items that have a sufficient number of streaming hours (e.g., streaming hours exceeds a certain threshold) or non-zero streaming hours (only), and content items that have zero streaming hours are not considered.

In some embodiments, popularity-related data of content items 302 may include popularity data for content items that have a sufficient number of non-zero streaming hours within the last Z number of days, and content items that have zero streaming hours within the last Z number of days are not considered.

In some embodiments, popularity-related data of content items 302 may be weighted. For example, the popularity-related data of content items 302 may have weights that correspond to recency of popularity data, where the weights may be higher for more recent popularity data. The weights may gradually decay over time according to a decay function.

In some embodiments, popularity-related data of content items 302 may include quantitative metrics that measure an amount of interaction a content item has received, or to what extent a content item is trending. Examples of quantitative metrics may include: number of impressions, number of clicks, number of launches, number of times a preview has been watched, amount of time the content item has been watched/consumed, release date (e.g., how recent was the content item released), whether the content item is part of a franchise that recently had a new release in the franchise, whether an actor (or associated person) in the content item is in the news, whether an actor (or associated person) in the content item is trending on social media), a number of times the title of the content item has been searched, a number of times an actor (or associated person) in the content item has been searched, whether the content item is part of an active marketing campaign, whether the content item is produced by a certain producer, a number of likes received, a number of dislikes received, critics' rating, viewers' rating, etc.

In some embodiments, popularity-related data of content items may include quantitative metrics for different demographics. In some embodiments, popularity-related data of content items may include quantitative metrics for different groups/clusters of content items. In some embodiments, popularity-related data of content items may include rate of change or trends of the quantitative metrics.

Popularity score calculator 304 may process the popularity-related data of content items 302 to generate respective popularity scores for the content items. Popularity scores may be computed based on the popularity-related data, such as the quantitative metrics or a derivation thereof. Popularity scores may include a sum of quantitative metrics. Popularity scores may include a weighted sum of quantitative metrics. An exemplary popularity score may be calculated based on:

w₁*launches+w₂*clicks.
w₁ and w₂ may be pre-determined and/or tuned weighing factors for individual quantitative metrics. launches may include a number of launches of the content item in the last Z number of days. clicks may include a number of clicks of the content item in the last Z number of days.

Popularity score calculator 304 may compute a normalized popularity score, which may normalize the popularity scores for a collection of content items based on the range of calculated popularity scores of the content items to that the normalized popularity score falls between 0 and 1.

Using the popularity scores, content item bucketizer 306 may implement one or more strategies to distribute the content items into cohorts of content items with similar popularity scores, referred herein as content item buckets or buckets. Content items may be distributed to X number of content item buckets: content item bucket 1 310₁, content item bucket 2 310₂, content item bucket 3 310₃, . . . and content item bucket X 310_{X}.

FIG. 4A depicts an exemplary plot of popularity scores of a number of content items, and considerations when bucketizing the content items, according to some embodiments of the disclosure. The content items are sorted based on (normalized) popularity scores from the highest (e.g., 1) to the lowest (e.g., 0). Popularity-related data of content items 302 may yield this plot with a negative exponential growth shape or exponential decay curve. A significantly few number of content items have a high normalized popularity score, and a significantly large number of content items have a low normalized popularity score.

When distributing the content items into cohorts or buckets, it may be desirable to (1) have similar number of items in each bucket, and/or (2) ensure that items in each bucket have similar popularity scores (e.g., variance of popularity scores of content items in a bucket is relatively low). In some cases, the content items are distributed into X cohorts or X buckets. X may be 10.

In some cases, content item bucketizer 306 may implement a percentile distribution approach. The percentile distribution approach may split content items based on the percentile group that content items fall into. Each bucket may have a corresponding percentile group, where the percentile group depends on 100 divided by X, where X is the number of buckets. If X=10, then content items may be distributed into the 90^{th} percentile group bucket, 80^{th} percentile group, 70^{th} percentile group . . . to 0^{th} percentile group. The percentile distribution approach may yield buckets where number of items per bucket is uniform across buckets, but the popularity scores of content items in a bucket may have a high variance (due to the distribution of popularity scores as illustrated in FIG. 4A). FIG. 4B depicts an exemplary plot of number of content items per percentile group, according to some embodiments of the disclosure. As seen in FIG. 4B, the number of content items in each one of the X=10 percentile groups are the same. FIG. 4C depicts an exemplary plot of popularity scores for each percentile group, according to some embodiments of the disclosure. FIG. 4D depicts an exemplary table of statistics about the popularity scores for each percentile group, according to some embodiments of the disclosure. As seen in FIGS. 4C-D, popularity score spread in group 1 is significantly higher than the popularity score spread in groups 2-10. Group 1, in particular, may include a large spread of popular content items and unpopular content items, with most content items being unpopular content items. Popular content items are captured as outliers in FIG. 4C. The mean of popularity score is relatively low, and the standard deviation is relatively high. The number of content items in per percentile group, or count, is substantially the same.

In some cases, content item bucketizer 306 may implement a Pareto distribution approach, e.g., 50%-50% split, 60%-40% split, 80%-20% split, to recursively split content items and place some items into a bucket at each split until a desired number of buckets have been reached. In some embodiments, content item bucketizer 306 implements a recursive 80%-20% split. The content items may have corresponding popularity scores, and an exemplary distribution of popularity scores is illustrated in FIG. 4A. First, content items that contribute to the top 80% of the popularity score may be identified (e.g., content items that have a normalized popularity score at or above 0.8). The identified content items that contribute to the top 80% of the popularity score may be placed into a bucket. Then, the remaining content items, e.g., the content items that do not contribute to the top 80% of the popularity score (e.g., content items that have a normalized popularity score below 0.8) are examined further. The content items that contribute to the top 80% of the popularity score in the remaining content items may be identified (e.g., content items that have a normalized popularity score at or above 0.8*0.8=0.64). The identified content items that contribute to the top 80% of the popularity score in the remaining content items may be placed into a bucket. Then, the remaining content items (e.g., content items that have a normalized popularity score below 0.64) are examined further. The content items that contribute to the top 80% of the popularity score in the remaining content items may be identified (e.g., content items that have a normalized popularity score at or above 0.8*0.64=0.512). The identified content items that contribute to the top 80% of the popularity score in the remaining content items may be placed into a bucket. Then, the remaining content items (e.g., content items that have a normalized popularity score below 0.512) are examined further. The process may be repeated until content items are distributed to X buckets. The Pareto distribution approach to recursively split the content items into two parts may yield buckets where popularity scores have a relatively low variance in each bucket, but the number of items per bucket may vary wildly (due to the distribution of popularity scores as illustrated in FIG. 4A). FIG. 4E depicts an exemplary plot of number of content items per Pareto group, according to some embodiments of the disclosure. As seen in FIG. 4E, the number of content items in each one of the X=10 Pareto groups are not the same. Number of content items per Pareto group is skewed, where group 1 has the fewest number of content items, and group 10 has many number of content items. FIG. 4F depicts an exemplary plot of popularity scores for each Pareto group, according to some embodiments of the disclosure. FIG. 4G depicts an exemplary table of statistics about the popularity scores for each Pareto group, according to some embodiments of the disclosure. As seen in FIGS. 4F-G, group 1 has a large spread of popular content items and unpopular content items. However, group 1 has a balance of popular and unpopular content items. Mean of popularity scores of group 1 obtained with the Pareto distribution approach is relatively higher than the mean of popularity of scores of group 1 obtained by percentile distribution approach. Because most items (e.g., the long-tailed items) have close to 0 as the popularity score and barely contribute to the top 80% of the popularity scores, the number of content items in per Pareto group, or count, is skewed.

In some cases, content item bucketizer 306 may implement a geometric progression based distribution approach. The geometric progression based distribution approach is not recursive and distributes the content items in a geometric fashion (e.g., according to a geometric sequence). A total number of content items (e.g., number of content items that have non-zero streaming hours in the last Z number of days), shown as #items below, may equal to a sum of a geometric sequence:

$$\#items = bbs + bbs * r + bbs * {r}^{2} + bbs * {r}^{3} + … + bbs * {r}^{C}$$

bbs may represent a base group size and may be pre-determined or tuned. bbs may be 500 (but can be another suitable value). #items is known. C may represent the number of buckets or cohorts minus 1, or X−1. C=X−1, or X=C+1. The equation above can be rewritten as follows:

$$\#items * r = r * ( bbs + bbs * r + bbs * {r}^{2} + bbs * {r}^{3} + … + bbs * {r}^{C} )$$

$$\#items * r = bbs * r + bbs * {r}^{2} + bbs * {r}^{3} + … + bbs * {r}^{C} + bbs * {r}^{C + 1}$$

$$\#items * r - bbs * {r}^{C + 1} = bbs * r + bbs * {r}^{2} + bbs * {r}^{3} + … + bbs * {r}^{C}$$

$$\#items - bbs = bbs * r + bbs * {r}^{2} + bbs * {r}^{3} + … + bbs * {r}^{C}$$

$$\#items - bbs = \#items * r - bbs * {r}^{C + 1}$$

$$bbs * {r}^{C + 1} - \#items * r + ( \#items - bbs ) = 0$$

$$bbs * {r}^{X} - \#items * r + ( \#items - bbs ) = 0$$

Content item bucketizer 306 may solve for r to distribute the content items according to the geometric sequence: bucket 1 may have the bbs number of content items having the highest popularity scores, bucket 2 may have bbs*r number of content items, bucket 3 may have bbs*r² number of content items having the next highest popularity scores, bucket 4 may have bbs*r³ number of content items having the next highest popularity scores, . . . and bucket X may have bbs*r^{C} number of content items having the lowest popularity scores. The geometric progression based distribution approach may yield buckets whose number of content items increases from bucket 1 to bucket X. Popularity scores of content items in a bucket may have relatively low variance e.g., when bbs is tuned appropriately for the distribution of popularity scores as illustrated in FIG. 4A. bbs can be fine-tuned for a given #items and shape of the distribution of popularity scores. The geometric progression based distribution approach can be tuned such that (1) the variance in popularity scores of content items in each bucket and (2) the variance in the number of items per bucket is minimized. For example, parameter bbs can be optimized (e.g., tried or tested at different values) to minimize (1) the variance in popularity scores of content items in each bucket and (2) the variance in the number of items per bucket. FIG. 4H depicts an exemplary plot of number of content items per geometric progression group, according to some embodiments of the disclosure. As seen in FIG. 4H, the number of content items in each one of the X=10 geometric progression groups are not the same. Number of content items per geometric progression group becomes bigger from group 1 to group 10, where group 1 has the fewest number of content items, the number of content items in group 2, 3, 4, 5 . . . and so on grows controllably according to the geometric sequence. FIG. 4I depicts an exemplary plot of popularity scores for each geometric progression group, according to some embodiments of the disclosure. FIG. 4J depicts an exemplary table of statistics about the popularity scores for each percentile group, according to some embodiments of the disclosure. The resulting popularity spread and standard deviation per geometric progression group are better controlled by finding the appropriate base group size bbs.

It is envisioned by the disclosure that other scores associated with content items besides popularity scores can be used with or in place of popularity scores when distributing content items into different buckets, clusters, or cohorts, using any one or more approaches illustrated in FIGS. 4B-J.

Preferably, content item buckets include cohorts or clusters of content items that may share similarities with one or more features, attributes, or dimensions of the content items. In some cases, a clustering technique can be applied to generate different content item buckets.

### Using Buckets to Debias Training Data

As discussed with FIG. 2, it is possible to use models or computer-implemented processes to generate training data, e.g., labeled data entries having query and content item pairs with corresponding match values. Models or processes can programmatically search for matches (e.g., matching content items) to a query and translate the matches into training data. Models or processes can include, e.g., processes that uses machine learning models to search for matches to a query, processes that searches through a relational database for matches to a query, processes that searches through a semantic graph for matches to a query, etc. In some cases, these models or processes may return mostly if not all long-tailed items having high semantic affinity scores but low popularity scores. These models or processes may return long-tailed items that have high semantic affinity but low affinity in other dimensions. If popularity or other dimensions are not taken into account, the generated training data would include mostly if not all long-tailed items that may not be very popular or lack affinity in other dimensions.

Debiasing of training data to take popularity into account can occur by ensuring, restricting, or enforcing processes searching for matches to a query to perform the search within individual content item buckets or cohorts, and aggregating sets of top K matches from all content item buckets to form the set of training data.

K may be 10. K may depend on the expected number of matches to the query and the number of content item buckets. K may depend on the total number of content items. K may depend on a total number of content items in a given content item bucket. K may vary for the given content item bucket. K may be tuned or optimized using reinforcement learning, where reward can be calculated based on one or more feedback signals, such as the semantic relevance of the items in the bucket, and the reward can be used to optimize/tune particular K's corresponding to different buckets. Reward may be used to update parameters of a model that is able to generate K's based on a given query. K used for the different content buckets may be tuned or optimized for a given query. Particular K's corresponding to different buckets may be tuned or optimized for a given query.

The content item buckets can be created based on, e.g., popularity scores of the content items using one or more strategies described with FIGS. 3 and 4A-J. Content item buckets can split the content items into different groups based on one or more features, attributes, and dimensions about the content items. Groups may represent cohorts or clusters of content items having similar features, attributes, and dimensions.

The aggregated matches from each one of the content item buckets can then be used as training data. Advantageously, the aggregated results can include content items having a balanced distribution of one or more features, attributes, and dimensions about the content items, such as popularity scores. The aggregated results can include content items having varied popularity scores (not just content items with high semantic affinity scores but low popularity scores). The training data that is generated from the aggregated results thus would have a balanced distribution of content items having varied scores, such as popularity scores. A model that is trained on the training data would ensure that the model gets a balanced exposure of scores (e.g., popularity scores) in the training data, and not skew solely to semantic affinity. This approach contrasts with searching for matches to a query across the entire catalogue of content items without regard to other affinities such as popularity scores.

When searching for matches to a query across an entire catalogue, a query for drama may return 100 content items that have a high semantic relevance to drama but are unpopular. A model trained on training data generated from the 100 content items that includes mostly unpopular content items would converge or fit to retrieve unpopular content items when a user queries for drama.

In contrast, when searching for matches in individual content item buckets and aggregating top 10 matches from each one of the X=10 content item buckets, the training data that is generated from the 100 content items may have a mix of popular and unpopular content items. A model trained on training data generated from these 100 content items that includes a mix of popular and unpopular content items would retrieve content items that balance semantic affinity/relevance and popularity when a user queries for drama.

FIG. 5 depicts debiasing training data and retrieval of top K items from each content item buckets, according to some embodiments of the disclosure. The LLM 504 may receive query 502 and translate query 502 into a feature vector 506. The feature vector may be provided to item retrieval from buckets 560. The feature vector 506 may include features which are extracted by the LLM 504 that are salient to or are characteristic of the query 502.

Item retrieval from buckets 560 may include X number of processes that searches within respective content item buckets for top K content items that matches the query 502 (e.g., the feature vector of the query 502). The processes may receive feature vector 506 as input. The X number of processes may include retrieve top K from bucket 1 520₁, retrieve top K from bucket 2 520₂, . . . , and retrieve top K from bucket X 520_{X}. For example, retrieve top K from bucket 1 520₁ may use feature vector 506 to find top K number of matches in content item bucket 1 to the query 502 using feature vector 506. Retrieve top K from bucket 1 520₁ may output top K from bucket 1 530₁. Retrieve top K from bucket 2 520₂ may use feature vector 506 to find top K number of matches in content item bucket 2 to the query 502 using feature vector 506. Retrieve top K from bucket 2 520₂ may output top K from bucket 2 530₂. Retrieve top K from bucket X 520_{X} may use feature vector 506 to find top K number of matches in content item bucket X to the query 502 using feature vector 506. Retrieve top K from bucket X 520_{X} may output top K from bucket X 530_{X}.

Top K matches, including top K from bucket 1 520₁, top K from bucket 2 520₂, . . . and top K from bucket X 520_{X} may be (optionally) aggregated together by merge 540. In some cases, merge 540 may perform aggregation of the top K matches into a set of matches and output the set of matches as retrieved set 550.

In some embodiments, merge 540 may implement balancing processes and/or trimming processes on top K matches from different buckets to remove one or more items which do not meet a certain criterion. In some cases, one or more matches in the top K matches from different buckets that are not sufficiently semantically relevant to query 502 and may be removed by merge 540.

In some cases, merge 540 may determine a balance score that includes a semantic affinity score and a popularity score for the matches in the top K matches. Semantic affinity score may be determined in the processes that find matches to the feature vector 506, such as retrieve top K from bucket 1 520₁, retrieve top K from bucket 2 520₂, . . . , and retrieve top K from bucket X 520_{X}. The semantic affinity score may quantify how well the match or content item matches the query 502. The popularity score may be determined as discussed with FIG. 3. The balance score may include a weighted sum of the semantic affinity score and the popularity score. The respective weights may be pre-determined. The respective weights may be tuned or optimized for a given query. Merge 540 may rank the matches in the top K matches based on the balance score (or the semantic affinity score only) and discard or filter out certain matches before outputting the matches in the top K matches as retrieved set 550. The matches may have a balance score that crosses a pre-determined minimum threshold. The pre-determined minimum threshold may be tuned or optimized for a given query. The matches may have a semantic affinity score that crosses a further pre-determined minimum threshold. The further pre-determined minimum threshold may be tuned or optimized for a given query. Merge 540 may output top M scoring matches as retrieved set 550. M may be tuned or optimized for a given query. Merge 540 may input the matches in the top K matches from different buckets and the query into an LLM and ask the LLM to output a filtered set or reduced set (e.g., a set of M matches) that represents the most semantically relevant matches to the query. Merge 540 may input the top K matches from a given bucket and the query into an LLM and ask the LLM to output a filtered set or reduced set that represents the most semantically relevant matches to the query. Merge 540 may transform a match in the various top K matches into a question prompt, such as, “Answer in yes or no. Is {title of content item} a {query}? Context: {content item metadata}”. The question prompt preferably asks the question and answer LLM model whether a content item, given the content item metadata associated with the content item, is associated with a given query. The question and answer LLM model may be able to identify matches that are falsely retrieved. Merge 540 may implement a fact checking model, which may search a data source for a certain number of reputable references that can confirm the content item matches the query.

The retrieved set 550 may be translated into labeled data entries for use as training data.

As illustrated in FIG. 5, item retrieval from buckets 560 may include one or more balancing parameters which can be tuned or optimized. Optimize balancing parameter(s) 590 may receive query 502 as input and determine optimized balancing parameter(s) for any one or more parts in item retrieval from buckets 560. Optimize balancing parameter(s) 590 may implement a model that can be trained or updated based on one or more feedback signals to generate optimized balancing parameter(s).

Balancing parameters may be parameters that can impact the balance of different types of affinities in retrieved set 550. Balancing parameters may be parameters that can impact whether too many long-tailed items are being retrieved in retrieved set 550. Balancing parameters may be parameters that can impact whether too many semantically irrelevant content items are being retrieved in retrieved set 550. Balancing parameters may be parameters that can impact whether too many content items which are not useful to a user inputting the query are being retrieved in retrieved set 550. In particular, the one or more balancing parameters may be tuned or optimized for a given query.

Balancing parameters may include K's used in the top K retrieval from buckets in retrieve top K from bucket 1 520₁, retrieve top K from bucket 2 520₂, . . . , and retrieve top K from bucket X 520_{X}. Balancing parameters may include the weights used in calculating a balance score for content items in merge 540. Balancing parameters may include the threshold(s) used in filtering out certain content items in merge 540. Balancing parameters may include M used in selecting the top M content items to output as retrieved set 550.

The one or more balancing parameters may be tuned or optimized using reinforcement learning, using rewards that capture the quality of the content items, e.g., in retrieved set 550 to a given query. The one or more balancing parameters may be tuned or optimized (e.g., iteratively) using one or more feedback signals, that capture the quality of the content items, e.g., in retrieved set 550 to a given query. Feedback signals may include semantic affinity scores of items which are retrieved for a query using a particular set of balancing parameters. Feedback signals may include a count of content items meeting a certain quality criterion, e.g., having a sufficiently high score (e.g., which may indicate the quality of the balancing parameters being used to pick the content items). Feedback signals may include other suitable scores measuring the quality of the items which are retrieved for a query using a particular set of balancing parameters. Feedback signals may include scores and/or rankings generated by an LLM by prompting the LLM using the query and the content items which were retrieved for a query using a particular set of balancing parameters. Feedback signals may include responses generated by an LLM by prompting the LLM using the query and one or more content items which were retrieved for a query using a particular set of balancing parameters. Feedback signals may include human feedback, such as (prolonged) user interaction or engagement with a particular item after a user inputs the query. Feedback signals may include expert human feedback reviewing the content items retrieved for the query using a given set of balancing parameters.

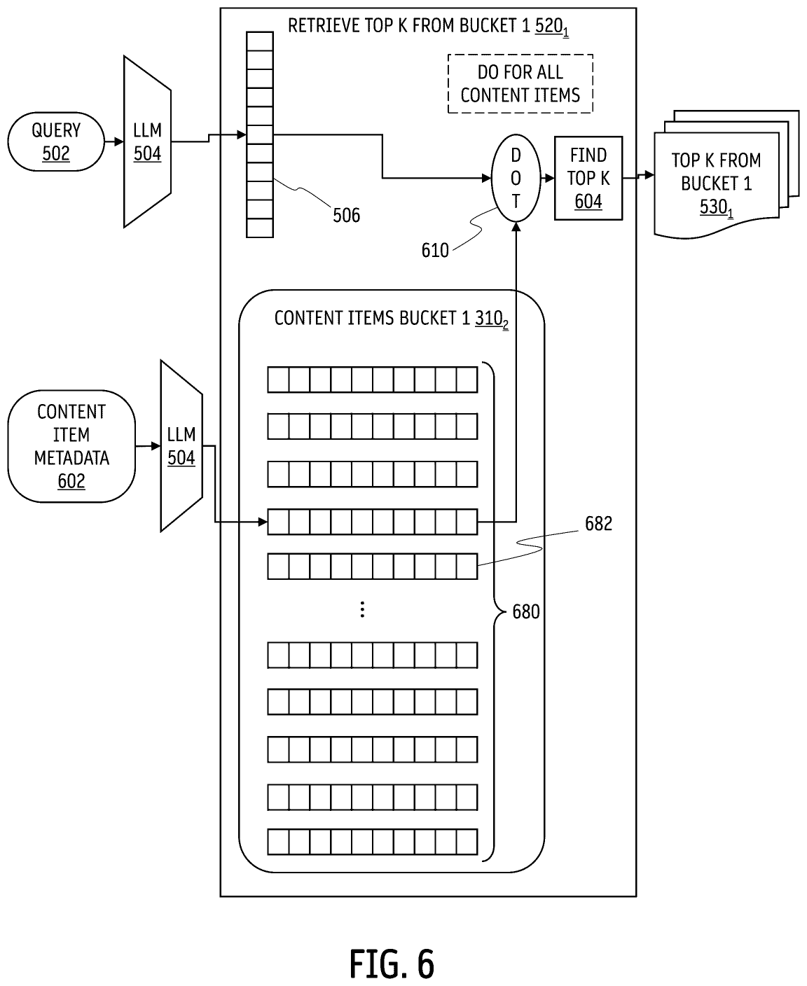

FIG. 6 depicts retrieval of top K items (e.g., closest K nearest neighbors) from a content item bucket, specifically, retrieval of top K items from content items bucket 1 310₂ by retrieve top K from bucket 1 520₁ of FIG. 5, according to some embodiments of the disclosure. To facilitate a comparison between query 502 and content items in content items bucket 1 310₂, query 502 can be transformed into a feature vector 506 using LLM 504, and content item metadata 602 corresponding to the content items can be transformed into respective feature vectors 680 using LLM 504. As an illustration, LLM 504 can generate feature vector 682 that corresponds to a particular content item in content items bucket 1 310₂. Content item metadata 602 used for generating feature vector 682 can include one or more of: plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, etc. Content item metadata 602 that corresponds to a particular content item can be used as input to LLM 504, and LLM 504 can transform the input into a feature vector, such as feature vector 682.

Feature vector 506 and feature vectors 680 can be in the same feature space to allow comparisons or degree of match between the query 502 and a given content item to be performed or determined. Feature vector 506 can represent salient features of query 502, as interpreted by LLM 504. Feature vectors 680 can represent salient features of respective content items as interpreted by LLM 504. Using feature vector 506 and feature vectors 680, retrieve top K from bucket 1 520₁ can determine how semantically related the query 502 and a given content item are to each other (e.g., a semantic affinity score of the given item to query 502). Comparison between query 502 and a given content item can be performed in a variety of ways. In the illustration shown, dot product 610 can find a dot product 610 of feature vector 506 and a feature vector 682 of a content item. The result of dot product 610 can represent how closely the query 502 semantically matches a given content item. Dot product 610 may repeat determining the dot product for all feature vectors of content items, one by one, against feature vector 506. The dot product results produced by dot product 610 over the content items in content items bucket 1 310₂ can be ranked, sorted, or processed, by find top K 604, to determine top K dot products (e.g., top K dot products having the highest values). The content items correspond to the top K dot products may then be determined as the top K matches and output as top K from bucket 1 530₁.

Retrieve top K from bucket 2 520₂, . . . and retrieve top K from bucket X 520_{X} of FIG. 5 may be implemented similarly to retrieve top K from bucket 1 520₁ for other content buckets. As an example, FIGS. 5-6 illustrate using LLM 504 as part of the process for finding matches to a query 502. It is envisioned by the disclosure that other processes or models, such as neural networks that can perform natural language processing (e.g., process and extract semantic information or features from natural language inputs), can be used in place of LLM 504 illustrated in FIG. 5-6 to find matches within content item buckets and to generate aggregated matches.

### Using an Ensemble of Models to Generate Diverse and Debiased Training Data

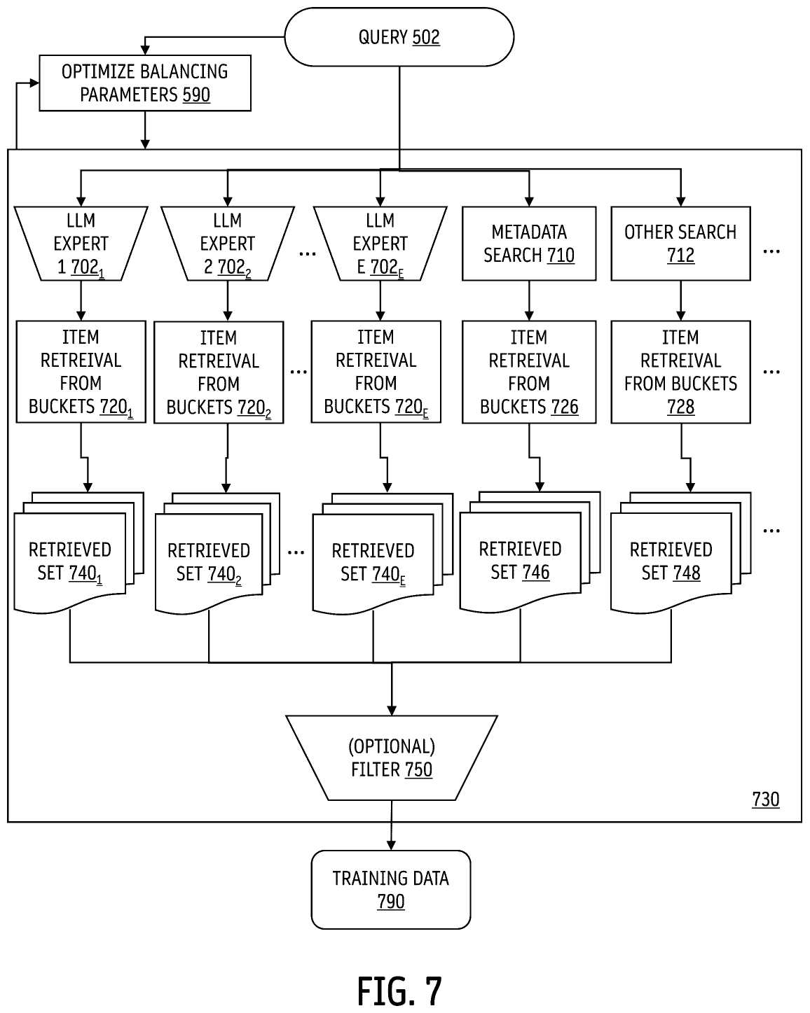

FIG. 7 depicts using an ensemble of models (e.g., an ensemble of techniques 730) to generate diverse and debiased training data, according to some embodiments of the disclosure. When generating training data 790 (e.g., training data that can be used as part of training data 132 to train model for specific task B 134 in FIG. 1), it is possible to generate matches to query 502 using an ensemble of techniques or models that searches for matches to query 502. One or more techniques or models may use, e.g., popularity buckets, to debias the matches that are found using the techniques. FIGS. 5-6 illustrate using an LLM as an exemplary technique.

FIG. 7 illustrates using a diverse set of expert LLMs, e.g., LLM expert 1 702₁, LLM expert 2 702₁, . . . . LLM expert E 702_{E} to generate a collection of matches to query 502. Different expert LLMs may pay attention to different parts of query 502 and content item metadata and generate different feature vectors as output. Using the diverse set of expert LLMs may explore and find matches to query 502 that are different from each other. One or more ones in the set of expert LLMs may perform searching for matches using popularity buckets, using item retrieval from buckets 720₁, item retrieval from buckets 720₂, . . . and item retrieval from buckets 720_{H}, as described in FIGS. 5-6, to output aggregated matches as retrieved set 740₁, retrieved set 740₂, . . . and retrieved set 740_{E}.

In some cases, query 502 may be provided to metadata search 710. Metadata search 710 may transform query 502 into a data structure that can be used to find content items that are semantically relevant or match the data structure. Metadata search 710 may perform natural language processing to extract salient keywords or concepts from query 502 and use the salient keywords or concepts as a data structure to find semantically relevant content items, e.g., through a reverse look up process. The search can be performed in individual content item buckets, by item retrieval from buckets 726 to generate retrieved set 746.

In some cases, query 502 may be provided to other search 712. Other search 712 may find content items that are semantically relevant to query 502 or find content items which are semantically related to a content item that is established to be relevant to query 502. The search can be performed in individual content item buckets, by item retrieval from buckets 728 to generate retrieved set 748.

It is envisioned that query 502 may be provided to one or more other search processes. The search processes may or may not perform searches in individual content item buckets.

The different retrieval techniques illustrated in the ensemble of techniques 730, including the different expert LLMs, metadata search 710, and other search 712, may output different number of items in retrieved set 740₁, retrieved set 740₂, . . . retrieved set 740_{E}, retrieved set 746, and retrieved set 748. The number of items retrieved by the various techniques may be the same. The number of items retrieved by the various techniques may be different. The number of items retrieved by the various techniques may be pre-determined. The number of items retrieved by the various techniques may be tuned or optimized. The number of items retrieved by the various techniques may be tuned or optimized for a given query, e.g., query 502. Balancing parameters of the ensemble of techniques 730 may include the number of items retrieved by the various techniques.

In some cases, filter 750 may be implemented to control the quality of the matches that becomes training data 790. Filter 750 may have one or more balancing parameters. Filter 750 may implement one or more techniques illustrated with merge 540. Filter 750 may be included to discard or filter out matches that may be falsely retrieved (e.g., a content item has no semantic relevance to query 502 but was retrieved from a content item bucket). Matches may be falsely retrieved due to some potential popularity bucket(s) not having content items that have a sufficiently high semantic affinity to query 502. Filter 750 may filter out matches that have a balance score that crosses a minimum balance score threshold. The minimum balance score threshold may be tuned or optimized for a given query, e.g., query 502. Filter 750 may filter out matches that have a semantic affinity score that crosses a minimum semantic affinity score threshold. The minimum semantic affinity score threshold may be tuned or optimized for a given query, e.g., query 502. Filter 750 may implement a question and answer LLM model. Filter 750 may transform a match in the various retrieved sets (e.g., retrieved set 740₁, retrieved set 740₂, . . . retrieved set 740_{E}, retrieved set 746, and retrieved set 748) into a question prompt, such as, “Answer in yes or no. Is {title of content item} a {query}? Context: {content item metadata}”. The question prompt preferably asks the question and answer LLM model whether a content item, given the content item metadata associated with the content item, is associated with a given query. The question and answer LLM model may be able to identify matches that are falsely retrieved. Filter 750 may implement a fact checking model, which may search a data source for a certain number of reputable references that can confirm the content item matches the query.

As illustrated in FIG. 7, ensemble of techniques 730 may include one or more balancing parameters which can be tuned or optimized. Optimize balancing parameter(s) 590 may receive query 502 as input and determine optimized balancing parameter(s) for any one or more parts in the ensemble of techniques 730. Optimize balancing parameter(s) 590 may determine optimized balancing parameter(s) any one or more parts in the ensemble of techniques 730 using mechanisms described with FIG. 5.

### Exemplary Computer-Implemented Methods

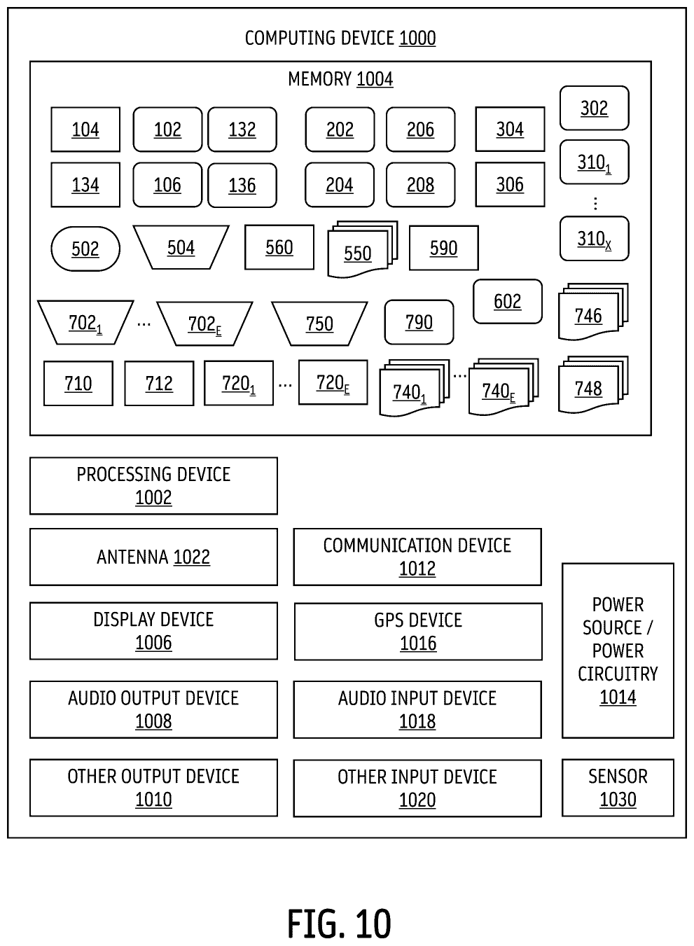

FIG. 8 is a flowchart showing a method for bucketizing content items based on popularity scores, according to some embodiments of the disclosure. Method 800 is illustrated. Method 800 may be implemented by the system illustrated in FIGS. 3 and 10.

In 802, a popularity score calculator may determine popularity scores for content items based on popularity-related data of content items. An exemplary popularity score calculator is illustrated in FIG. 3.

In 804, a content item bucketizer may distribute the content items into buckets based on the popularity scores. An exemplary content item bucketizer is illustrated in FIG. 3. The content item bucketizer may implement any one or more bucketizing, clustering, and content item distribution techniques described herein. Some techniques are illustrated in FIGS. 4B-J.

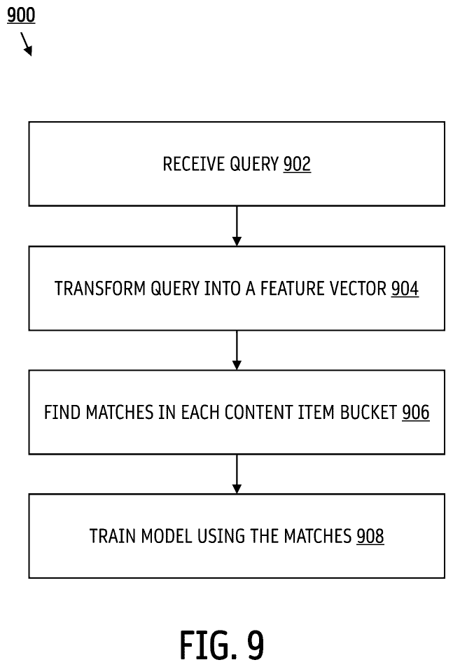

FIG. 9 is a flowchart showing a method for generating training data and using the training data in training a machine learning model, according to some embodiments of the disclosure. Method 900 is illustrated. Method 900 may be implemented by the system illustrated in FIGS. 5-7 and 10.

In 902, a model may receive a query. Query may include natural language text having semantic meaning. The model may include a large language model, or a machine learning model able to extract semantic meaning and/or patterns in natural language inputs. Examples of model are illustrated as LLM 504, LLM expert 1 702₁, . . . , and LLM expert E 702_{E}, in the FIGS.

In 904, the model may transform the query into a query feature vector. The feature vector may include a vector or matrix of values that represents features in the query, as interpreted or extracted by the model.

In 906, a retrieve top K from content bucket part may find a number of matches (e.g., top K matches) to the feature vector in respective content item buckets. Examples of retrieve top K from content bucket part and their implementations are illustrated in FIGS. 5-6. The content item buckets can group content items in a suitable way. For example, the content item buckets can group content items based at least on popularity scores of the content items. Method 800 of FIG. 8 can be used to produce content item buckets. One or more other suitable techniques for bucketizing, clustering, and content item distribution described herein can be applied.

In 908, a machine learning model may be trained using the matches from each content item bucket. Exemplary techniques for training a machine learning model (e.g., a model used in a content retrieval system) are illustrated in FIG. 1.

### Exemplary Computing Device

FIG. 10 is a block diagram of an exemplary computing device 1000, according to some embodiments of the disclosure. One or more computing devices 1000 may be used to implement the functionalities described with the FIGS. and herein. A number of components are illustrated in the FIGS. as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations described with the FIGS. and herein, such as the methods illustrated in FIGS. 8-9. Exemplary parts that may be encoded as instructions and stored in memory 1004 are depicted. Memory 1004 may store instructions that encode one or more exemplary parts. The instructions stored in the one or more non-transitory computer-readable media may be executed by processing device 1002. In some embodiments, memory 1004 may store data, e.g., data structures, binary data, bits, metadata, files, blobs, etc., as described with the FIGS. and herein. Exemplary data that may be stored in memory 1004 are depicted. Memory 1004 may store one or more data as depicted.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, a virtual reality system, an augmented reality system, a mixed reality system, or a wearable computer system. In some embodiments, the computing device 1000 may be any other electronic device that processes data.

### Select Examples

Example 1 provides a method, including receiving a query; transforming the query into a query feature vector; finding one or more matches to the query feature vector in each content item bucket of a plurality of content item buckets, where the plurality of content item buckets groups content items based on one or more attributes of the content items; and training a machine learning model using the one or more matches from each content item bucket.

Example 2 provides the method of example 1, where finding the one or more matches includes for a first content item bucket of the content item buckets, determining a dot product of a content item feature vector of each content item in the content item bucket and the query feature vector; and returning the one or more matches having content items that have the highest dot product values.

Example 3 provides the method of example 1 or 2, further including filtering the one or more matches found in the plurality of content item buckets based on a score computed for each match, and a pre-determined number of the one or more matches having the highest score values.

Example 4 provides the method of any one of examples 1-3, further including filtering the one or more matches found in the plurality of content item buckets based on a score computed for each match, and a threshold on score values computed for each match.

Example 5 provides the method of any one of examples 1-4, further including for a first match in the one or more matches found in the plurality of content item buckets, inputting a prompt to a large language model, the prompt including a question whether the first match, given metadata of the first match as context, is associated with the query; and removing the first match based on a negative response to the prompt.

Example 6 provides the method of any one of examples 1-5, further including determining a number of the one or more matches to find in the content item buckets based on the query.

Example 7 provides the method of any one of examples 1-6, further including updating a further model based on one or more feedback signals about the one or more matches found in each content item bucket; inputting the query into the further model; and determining a number of the one or more matches to find in each content item buckets using the further model.

Example 8 provides the method of example 7, where the one or more feedback signals includes a count of the one or more matches found in the plurality of content item buckets meeting a quality criterion.

Example 9 provides the method of any one of examples 1-8, where: the one or more attributes of the content items includes popularity.

Example 10 provides the method of any one of examples 1-9, further including determining scores for content items associated with the one or more attributes of the content items; and distributing the content items into the content item buckets based on the scores.

Example 11 provides the method of example 10, where distributing the content items into the content item buckets includes distributing the content items using a percentile approach.

Example 12 provides the method of example 10, where distributing the content items into the content item buckets includes distributing the content items using a recursive Pareto distribution approach.

Example 13 provides the method of example 10, where distributing the content items into the content item buckets includes distributing the content items to content item buckets, each content item bucket having a size which is set according to a geometric sequence, the geometric sequence having a base group size that is determined based on a target variance in the scores within individual content item buckets.

Example 14 provides the method of any one of examples 1-13, further including clustering the content items based on the one or more attributes of the content items to generate the one or more content item buckets having cohorts of content items that share similarities in the one or more attributes.

Example 15 provides one or more non-transitory computer-readable media having instructions stored thereon, when the instructions are executed by one or more processors, causes the one or more processors to: determine popularity scores based on popularity-related data of content items; split the content items into content item buckets based on the popularity scores; retrieve, using a first large language model, one or more matches in each content item bucket that semantically match a query; generate training data based on the one or more matches from each content item bucket; and update parameters of a machine learning model using the training data.

Example 16 provides the one or more non-transitory computer-readable media of example 15, where the instructions cause the one or more processors to: retrieve, using a second large language model, one or more further matches in each content item bucket that semantically match the query; where the training data is generated further based on the one or more further matches from each content item bucket retrieved using the second large language model.

Example 17 provides the one or more non-transitory computer-readable media of example 15, where the instructions cause the one or more processors to: generate the training data based further on one or more further matches from each content item bucket; where generating the training data based on the one or more matches and the one or more further matches includes filtering out content items that do not meet a criterion.

Example 18 provides a computer-implemented system including a first model to receive a query; a plurality of retrieve content item parts, including a first retrieve content items part to retrieve one or more first matches to the query from a first content item bucket; and a second retrieve content items part to retrieve one or more second matches to the query from a second content item bucket; a merge part to receive the one or more first matches and the one or more second matches and output a retrieved set of matches; and a content item retrieval system including a second model that is trained using the retrieved set of matches as training data.

Example 19 provides the computer-implemented system of example 18, further including a score calculator part to compute scores for content items; and a bucketizer part to distribute the content items into the first content item bucket and the second content item bucket based on the scores.

Example 20 provides the computer-implemented system of example 18 or 19, further including an optimizer part to determine a first number of the one or more first matches to retrieve and a second number of one or more second matches to retrieve for the query.

Example A provides one or more non-transitory computer-readable media storing instructions that, when executed by one or more processors, cause the one or more processors to perform any one of the methods provided in examples 1-14.

Example B provides an apparatus comprising means to carry out or means for carrying out any one of the computer-implemented methods provided in examples 1-14.

Example C provides a computer-implemented system, comprising one or more processors, and one or more non-transitory computer-readable media storing instructions that, when executed by the one or more processors, cause the one or more processors to perform any one of the methods provided in examples 1-14.

### Variations and Other Notes

Although the operations of the example methods shown in and described with reference to FIGS. 8-9 are illustrated as occurring once each and in a particular order, it will be recognized that the operations may be performed in any suitable order and repeated as desired. Additionally, one or more operations may be performed in parallel. Furthermore, the operations illustrated in FIGS. 8-9 may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
receiving a query;
transforming the query into a query feature vector;
finding one or more matches to the query feature vector in each content item bucket of a plurality of content item buckets, wherein the plurality of content item buckets groups content items based on one or more attributes of the content items; and
training a machine learning model using the one or more matches from each content item bucket.

2. The method of claim 1, wherein finding the one or more matches comprises:
for a first content item bucket of the content item buckets,
determining a dot product of a content item feature vector of each content item in the content item bucket and the query feature vector; and
returning the one or more matches having content items that have the highest dot product values.

3. The method of claim 1, further comprising:
filtering the one or more matches found in the plurality of content item buckets based on a score computed for each match, and a pre-determined number of the one or more matches having the highest score values.

4. The method of claim 1, further comprising:
filtering the one or more matches found in the plurality of content item buckets based on a score computed for each match, and a threshold on score values computed for each match.

5. The method of claim 1, further comprising:
for a first match in the one or more matches found in the plurality of content item buckets,
inputting a prompt to a large language model, the prompt comprising a question whether the first match, given metadata of the first match as context, is associated with the query; and
removing the first match based on a negative response to the prompt.

6. The method of claim 1, further comprising:
determining a number of the one or more matches to find in the content item buckets based on the query.

7. The method of claim 1, further comprising:
updating a further model based on one or more feedback signals about the one or more matches found in each content item bucket;
inputting the query into the further model; and
determining a number of the one or more matches to find in each content item buckets using the further model.

8. The method of claim 7, wherein the one or more feedback signals comprises a count of the one or more matches found in the plurality of content item buckets meeting a quality criterion.

9. The method of claim 1, wherein:
the one or more attributes of the content items comprises popularity.

10. The method of claim 1, further comprising:
determining scores for content items associated with the one or more attributes of the content items; and
distributing the content items into the content item buckets based on the scores.

11. The method of claim 10, wherein distributing the content items into the content item buckets comprises distributing the content items using a percentile approach.

12. The method of claim 10, wherein distributing the content items into the content item buckets comprises distributing the content items using a recursive Pareto distribution approach.

13. The method of claim 10, wherein distributing the content items into the content item buckets comprises distributing the content items to content item buckets, each content item bucket having a size which is set according to a geometric sequence, the geometric sequence having a base group size that is determined based on a target variance in the scores within individual content item buckets.

14. The method of claim 1, further comprising:
clustering the content items based on the one or more attributes of the content items to generate the one or more content item buckets having cohorts of content items that share similarities in the one or more attributes.

15. One or more non-transitory computer-readable media having instructions stored thereon, when the instructions are executed by one or more processors, causes the one or more processors to:
determine popularity scores based on popularity-related data of content items;
split the content items into content item buckets based on the popularity scores;
retrieve, using a first large language model, one or more matches in each content item bucket that semantically match a query;
generate training data based on the one or more matches from each content item bucket; and
update parameters of a machine learning model using the training data.

16. The one or more non-transitory computer-readable media of claim 15, wherein the instructions cause the one or more processors to:
retrieve, using a second large language model, one or more further matches in each content item bucket that semantically match the query;
wherein the training data is generated further based on the one or more further matches from each content item bucket retrieved using the second large language model.

17. The one or more non-transitory computer-readable media of claim 15, wherein the instructions cause the one or more processors to:
generate the training data based further on one or more further matches from each content item bucket;
wherein generating the training data based on the one or more matches and the one or more further matches comprises filtering out content items that do not meet a criterion.

18. A computer-implemented system comprising:
a first model to receive a query;
a plurality of retrieve content item parts, comprising:
a first retrieve content items part to retrieve one or more first matches to the query from a first content item bucket; and
a second retrieve content items part to retrieve one or more second matches to the query from a second content item bucket;
a merge part to receive the one or more first matches and the one or more second matches and output a retrieved set of matches; and
a content item retrieval system comprising a second model that is trained using the retrieved set of matches as training data.

19. The computer-implemented system of claim 18, further comprising:
a score calculator part to compute scores for content items; and
a bucketizer part to distribute the content items into the first content item bucket and the second content item bucket based on the scores.

20. The computer-implemented system of claim 18, further comprising:
an optimizer part to determine a first number of the one or more first matches to retrieve and a second number of one or more second matches to retrieve for the query.
